(19) United States
(12) Patent Application Publication
(10) Pub. No.: US 2022/0030483 A1
(43) Pub. Date: Jan. 27, 2022

(54) CONDITIONAL HANDOVER PROCEDURE SIGNALING

(71) Applicant: QUALCOMM Incorporated, San Diego, CA (US)

(72) Inventors: Peng CHENG, Beijing (CN); Karthika PALADUGU, San Diego, CA (US); Huichun LIU, Beijing (CN); Gavin Bernard HORN, La Jolla, CA (US)

(21) Appl. No.: 17/309,590

(22) PCT Filed: Dec. 9, 2019
(86) PCT No.: PCT/CN2019/123950

§ 371 Date: Jun. 8, 2021

(51) Int. Cl. H04W 36/00; H04W 76/30

(52) U.S. Cl. CPC H04W 36/00837; H04W 36/0061; H04W 76/30; H04W 36/0058

(57) ABSTRACT

Various aspects of the present disclosure generally relate to wireless communication. In some aspects, a user equipment (UE) may determine to perform a conditional handover procedure to transfer from a source cell to a target cell of a plurality of candidate target cells. The UE may transmit, to the source cell, a conditional handover execution message to indicate the conditional handover procedure to transfer from the source cell to the target cell based at least at least in part on determining to perform the conditional handover procedure. The UE may communicate with the target cell to transfer to the target cell based at least in part on determining to perform the conditional handover procedure. Numerous other aspects are provided.

### CROSS-REFERENCE TO RELATED APPLICATION

This application claims priority to Patent Cooperation Treaty (PCT) Application No. PCT/CN2018/120087, filed on Dec. 10, 2018, entitled “TECHNIQUES AND APPARATUSES FOR CONDITIONAL HANDOVER PROCEDURE SIGNALING,” which is hereby expressly incorporated by reference herein.

### FIELD OF THE DISCLOSURE

Aspects of the present disclosure generally relate to wireless communication, and to techniques and apparatuses for conditional handover procedure signaling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include determining to perform a conditional handover procedure to transfer from a source cell to a target cell of a plurality of candidate target cells. The method may include transmitting, to the source cell, a conditional handover execution message to indicate the conditional handover procedure to transfer from the source cell to the target cell based at least at least in part on determining to perform the conditional handover procedure. The method may include communicating with the target cell to transfer to the target cell based at least in part on determining to perform the conditional handover procedure.

In some aspects, a UE for wireless communication may include memory and one or more processors operatively coupled to the memory. The memory and the one or more processors may be configured to determine to perform a conditional handover procedure to transfer from a source cell to a target cell of a plurality of candidate target cells. The memory and the one or more processors may be configured to transmit, to the source cell, a conditional handover execution message to indicate the conditional handover procedure to transfer from the source cell to the target cell based at least at least in part on determining to perform the conditional handover procedure. The memory and the one or more processors may be configured to communicate with the target cell to transfer to the target cell based at least in part on determining to perform the conditional handover procedure.

In some aspects, a non-transitory computer-readable medium may store one or more instructions for wireless communication. The one or more instructions, when executed by one or more processors of a UE, may cause the one or more processors to determine to perform a conditional handover procedure to transfer from a source cell to a target cell of a plurality of candidate target cells. The one or more instructions, when executed by the one or more processors of the UE, may cause the one or more processors to transmit, to the source cell, a conditional handover execution message to indicate the conditional handover procedure to transfer from the source cell to the target cell based at least at least in part on determining to perform the conditional handover procedure. The one or more instructions, when executed by the one or more processors of the UE, may cause the one or more processors to communicate with the target cell to transfer to the target cell based at least in part on determining to perform the conditional handover procedure.

In some aspects, an apparatus for wireless communication may include means for determining to perform a conditional handover procedure to transfer from a source cell to a target cell of a plurality of candidate target cells. The apparatus may include means for transmitting, to the source cell, a conditional handover execution message to indicate the conditional handover procedure to transfer from the source cell to the target cell based at least at least in part on determining to perform the conditional handover procedure. The apparatus may include means for communicating with the target cell to transfer to the target cell based at least in part on determining to perform the conditional handover procedure.

In some aspects, a method of wireless communication, performed by a base station, may include providing, to a UE, a configuration message identifying a set of cell configurations for a plurality of candidate target cells and a set of conditional handover conditions for the plurality of candidate target cells. The method may include receiving, from the UE, a conditional handover execution message to indicate a conditional handover procedure to transfer from the source cell to a target cell of the plurality of candidate target cells after providing the configuration message. The method may include communicating with the target cell to enable the UE to transfer to the target cell based at least in part on receiving the conditional handover execution message.

In some aspects, a source cell for wireless communication may include memory and one or more processors operatively coupled to the memory. The memory and the one or more processors may be configured to provide, to a UE, a configuration message identifying a set of cell configurations for a plurality of candidate target cells and a set of conditional handover conditions for the plurality of candidate target cells. The memory and the one or more processors may be configured to receive, from the UE, a conditional handover execution message to indicate a conditional handover procedure to transfer from the source cell to a target cell of the plurality of candidate target cells after providing the configuration message. The memory and the one or more processors may be configured to communicate with the target cell to enable the UE to transfer to the target cell based at least in part on receiving the conditional handover execution message.

In some aspects, a non-transitory computer-readable medium may store one or more instructions for wireless communication. The one or more instructions, when executed by one or more processors of a source cell, may cause the one or more processors to provide, to a UE, a configuration message identifying a set of cell configurations for a plurality of candidate target cells and a set of conditional handover conditions for the plurality of candidate target cells. The one or more instructions, when executed by the one or more processors of the source cell, may cause the one or more processors to receive, from the UE, a conditional handover execution message to indicate a conditional handover procedure to transfer from the source cell to a target cell of the plurality of candidate target cells after providing the configuration message. The one or more instructions, when executed by the one or more processors of the source cell, may cause the one or more processors to communicate with the target cell to enable the UE to transfer to the target cell based at least in part on receiving the conditional handover execution message.

In some aspects, an apparatus for wireless communication may include means for providing, to a UE, a configuration message identifying a set of cell configurations for a plurality of candidate target cells and a set of conditional handover conditions for the plurality of candidate target cells. The apparatus may include means for receiving, from the UE, a conditional handover execution message to indicate a conditional handover procedure to transfer from the source cell to a target cell of the plurality of candidate target cells after providing the configuration message. The apparatus may include means for communicating with the target cell to enable the UE to transfer to the target cell based at least in part on receiving the conditional handover execution message.

Aspects generally include a method, apparatus, system, computer program product, non-transitory computer-readable medium, user equipment, base station, wireless communication device, source cell, target cell, and processing system as substantially described herein with reference to and as illustrated by the accompanying drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3A is a block diagram conceptually illustrating an example of a frame structure in a wireless communication network, in accordance with various aspects of the present disclosure.

FIG. 3B is a block diagram conceptually illustrating an example synchronization communication hierarchy in a wireless communication network, in accordance with various aspects of the present disclosure.

FIG. 4 is a block diagram conceptually illustrating an example slot format with a normal cyclic prefix, in accordance with various aspects of the present disclosure.

FIG. 5 illustrates an example logical architecture of a distributed radio access network (RAN), in accordance with various aspects of the present disclosure.

FIG. 6 illustrates an example physical architecture of a distributed RAN, in accordance with various aspects of the present disclosure.

FIG. 7 is a diagram illustrating an example of conditional handover procedure signaling, in accordance with various aspects of the present disclosure.

FIG. 8 is a diagram illustrating an example of conditional handover procedure signaling, in accordance with various aspects of the present disclosure.

FIG. 9 is a diagram illustrating an example of conditional handover procedure signaling, in accordance with various aspects of the present disclosure.

FIG. 10 is a diagram illustrating an example of conditional handover procedure signaling, in accordance with various aspects of the present disclosure.

FIG. 11 is a diagram illustrating an example process performed, for example, by a user equipment, in accordance with various aspects of the present disclosure.

FIG. 12 is a diagram illustrating an example process performed, for example, by a source cell, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based at least in part on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

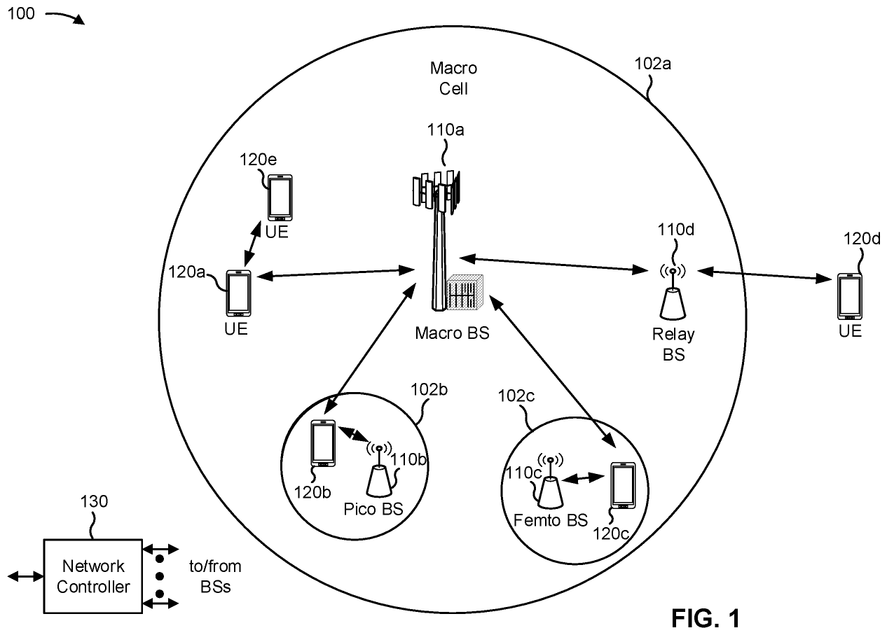

FIG. 1 is a diagram illustrating a network 100 in which aspects of the present disclosure may be practiced. The network 100 may be an LTE network or some other wireless network, such as a 5G or NR network. Wireless network 100 may include a number of BSs 110 (shown as BS 110a, BS 110b, BS 110c, and BS 110d) and other network entities. A BS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the access network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided merely as an example. Other examples may differ from what is described with regard to FIG. 1.

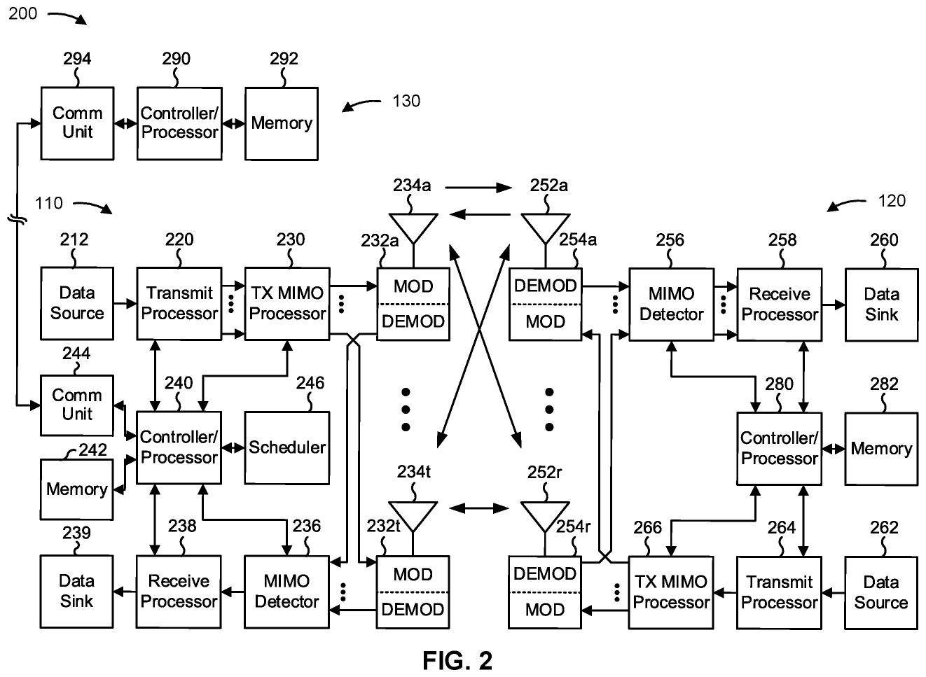

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

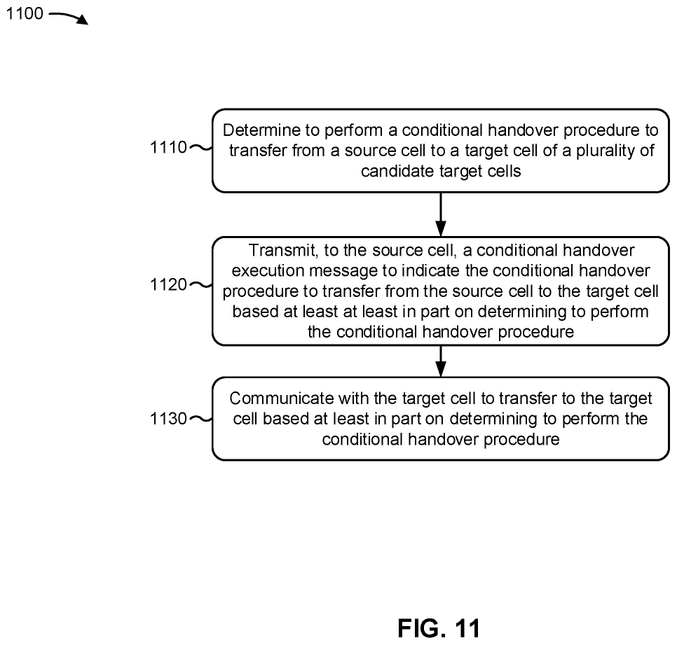

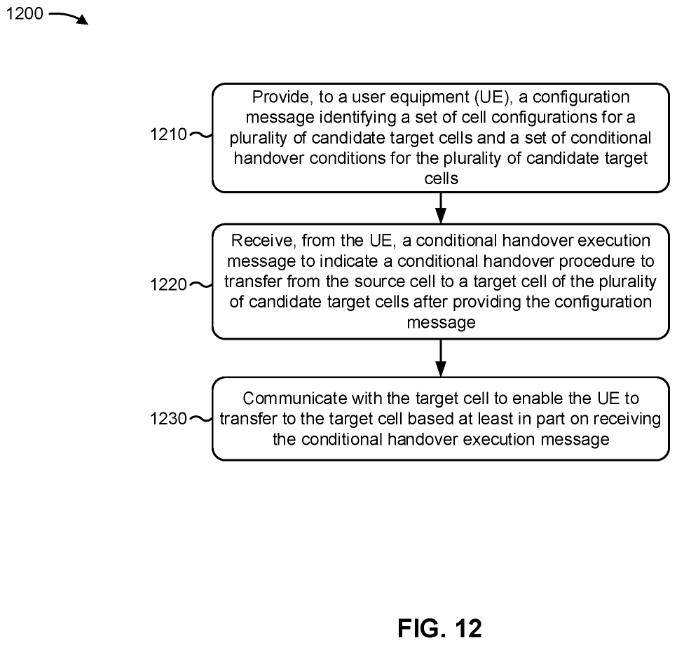

Controller/processor 240 of base station 110, controller/processor 280 of UE 120, and/or any other component(s) of FIG. 2 may perform one or more techniques associated with conditional handover procedure signaling, as described in more detail elsewhere herein. For example, controller/processor 240 of base station 110, controller/processor 280 of UE 120, and/or any other component(s) of FIG. 2 may perform or direct operations of, for example, process 1100 of FIG. 11, process 1200 of FIG. 12, and/or other processes as described herein. Memories 242 and 282 may store data and program codes for base station 110 and UE 120, respectively. A scheduler 246 may schedule UEs for data transmission on the downlink and/or uplink.

In some aspects, UE 120 may include means for determining to perform a conditional handover procedure to transfer from a source cell to a target cell of a plurality of candidate target cells, means for transmitting, to the source cell, a conditional handover execution message to indicate the conditional handover procedure to transfer from the source cell to the target cell based at least at least in part on determining to perform the conditional handover procedure, means for communicating with the target cell to transfer to the target cell based at least in part on determining to perform the conditional handover procedure, and/or the like. In some aspects, such means may include one or more components of UE 120 described in connection with FIG. 2.

In some aspects, base station 110 may include means for providing, to a user equipment (UE), a configuration message identifying a set of cell configurations for a plurality of candidate target cells and a set of conditional handover conditions for the plurality of candidate target cells, means for receiving, from the UE, a conditional handover execution message to indicate a conditional handover procedure to transfer from the source cell to a target cell of the plurality of candidate target cells after providing the configuration message, means for communicating with the target cell to enable the UE to transfer to the target cell based at least in part on receiving the conditional handover execution message, and/or the like. In some aspects, such means may include one or more components of base station 110 described in connection with FIG. 2.

As indicated above, FIG. 2 is provided merely as an example. Other examples may differ from what is described with regard to FIG. 2.

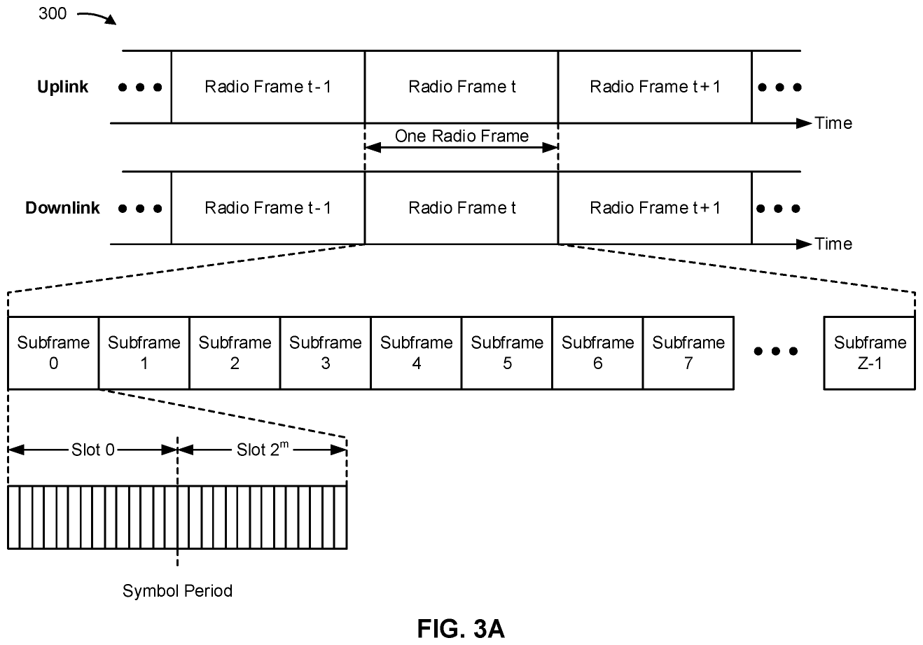

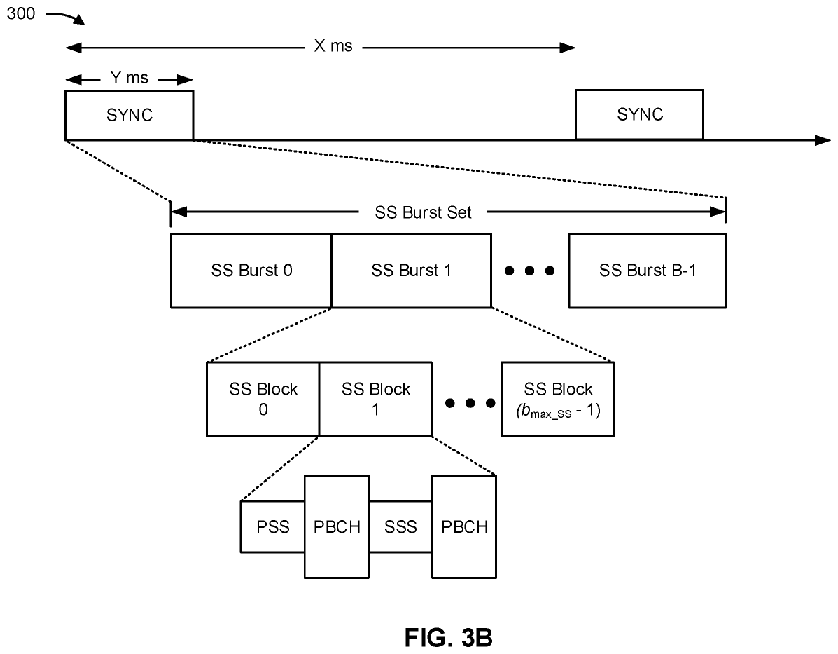

FIG. 3A shows an example frame structure 300 for frequency division duplexing (FDD) in a telecommunications system (e.g., NR). The transmission timeline for each of the downlink and uplink may be partitioned into units of radio frames (sometimes referred to as frames). Each radio frame may have a predetermined duration (e.g., 10 milliseconds (ms)) and may be partitioned into a set of Z (Z≥1) subframes (e.g., with indices of 0 through Z-1). Each subframe may have a predetermined duration (e.g., 1 ms) and may include a set of slots (e.g., 2^{m} slots per subframe are shown in FIG. 3A, where m is a numerology used for a transmission, such as 0, 1, 2, 3, 4, and/or the like). Each slot may include a set of L symbol periods. For example, each slot may include fourteen symbol periods (e.g., as shown in FIG. 3A), seven symbol periods, or another number of symbol periods. In a case where the subframe includes two slots (e.g., when m=1), the subframe may include 2L symbol periods, where the 2L symbol periods in each subframe may be assigned indices of 0 through 2L-1. In some aspects, a scheduling unit for the FDD may be frame-based, subframe-based, slot-based, symbol-based, and/or the like.

While some techniques are described herein in connection with frames, subframes, slots, and/or the like, these techniques may equally apply to other types of wireless communication structures, which may be referred to using terms other than “frame,” “subframe,” “slot,” and/or the like in 5G NR. In some aspects, a wireless communication structure may refer to a periodic time-bounded communication unit defined by a wireless communication standard and/or protocol. Additionally, or alternatively, different configurations of wireless communication structures than those shown in FIG. 3A may be used.

In certain telecommunications (e.g., NR), a base station may transmit synchronization signals. For example, a base station may transmit a primary synchronization signal (PSS), a secondary synchronization signal (SSS), and/or the like, on the downlink for each cell supported by the base station. The PSS and SSS may be used by UEs for cell search and acquisition. For example, the PSS may be used by UEs to determine symbol timing, and the SSS may be used by UEs to determine a physical cell identifier, associated with the base station, and frame timing. The base station may also transmit a physical broadcast channel (PBCH). The PBCH may carry some system information, such as system information that supports initial access by UEs.

In some aspects, the base station may transmit the PSS, the SSS, and/or the PBCH in accordance with a synchronization communication hierarchy (e.g., a synchronization signal (SS) hierarchy) including multiple synchronization communications (e.g., SS blocks), as described below in connection with FIG. 3B.

FIG. 3B is a block diagram conceptually illustrating an example SS hierarchy, which is an example of a synchronization communication hierarchy. As shown in FIG. 3B, the SS hierarchy may include an SS burst set, which may include a plurality of SS bursts (identified as SS burst 0 through SS burst B-1, where B is a maximum number of repetitions of the SS burst that may be transmitted by the base station). As further shown, each SS burst may include one or more SS blocks (identified as SS block 0 through SS block (b_{max_SS}-1), where b_{max_SS}-1 is a maximum number of SS blocks that can be carried by an SS burst). In some aspects, different SS blocks may be beam-formed differently. An SS burst set may be periodically transmitted by a wireless node, such as every X milliseconds, as shown in FIG. 3B. In some aspects, an SS burst set may have a fixed or dynamic length, shown as Y milliseconds in FIG. 3B.

The SS burst set shown in FIG. 3B is an example of a synchronization communication set, and other synchronization communication sets may be used in connection with the techniques described herein. Furthermore, the SS block shown in FIG. 3B is an example of a synchronization communication, and other synchronization communications may be used in connection with the techniques described herein.

In some aspects, an SS block includes resources that carry the PSS, the SSS, the PBCH, and/or other synchronization signals (e.g., a tertiary synchronization signal (TSS)) and/or synchronization channels. In some aspects, multiple SS blocks are included in an SS burst, and the PSS, the SSS, and/or the PBCH may be the same across each SS block of the SS burst. In some aspects, a single SS block may be included in an SS burst. In some aspects, the SS block may be at least four symbol periods in length, where each symbol carries one or more of the PSS (e.g., occupying one symbol), the SSS (e.g., occupying one symbol), and/or the PBCH (e.g., occupying two symbols).

In some aspects, the symbols of an SS block are consecutive, as shown in FIG. 3B. In some aspects, the symbols of an SS block are non-consecutive. Similarly, in some aspects, one or more SS blocks of the SS burst may be transmitted in consecutive radio resources (e.g., consecutive symbol periods) during one or more slots. Additionally, or alternatively, one or more SS blocks of the SS burst may be transmitted in non-consecutive radio resources.

In some aspects, the SS bursts may have a burst period, whereby the SS blocks of the SS burst are transmitted by the base station according to the burst period. In other words, the SS blocks may be repeated during each SS burst. In some aspects, the SS burst set may have a burst set periodicity, whereby the SS bursts of the SS burst set are transmitted by the base station according to the fixed burst set periodicity. In other words, the SS bursts may be repeated during each SS burst set.

The base station may transmit system information, such as system information blocks (SIBs) on a physical downlink shared channel (PDSCH) in certain slots. The base station may transmit control information/data on a physical downlink control channel (PDCCH) in C symbol periods of a slot, where B may be configurable for each slot. The base station may transmit traffic data and/or other data on the PDSCH in the remaining symbol periods of each slot.

As indicated above, FIGS. 3A and 3B are provided as examples. Other examples may differ from what is described with regard to FIGS. 3A and 3B.

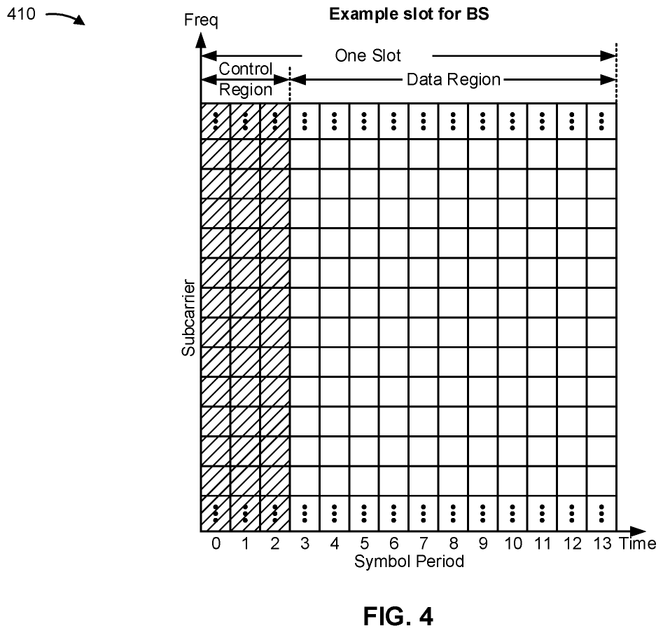

FIG. 4 shows an example slot format 410 with a normal cyclic prefix. The available time frequency resources may be partitioned into resource blocks. Each resource block may cover a set of subcarriers (e.g., 12 subcarriers) in one slot and may include a number of resource elements. Each resource element may cover one subcarrier in one symbol period (e.g., in time) and may be used to send one modulation symbol, which may be a real or complex value.

An interlace structure may be used for each of the downlink and uplink for FDD in certain telecommunications systems (e.g., NR). For example, Q interlaces with indices of 0 through Q-1 may be defined, where Q may be equal to 4, 6, 8, 10, or some other value. Each interlace may include slots that are spaced apart by Q frames. In particular, interlace q may include slots q, q+Q, q+2Q, etc., where q∈{0, . . . , Q-1}.

A UE may be located within the coverage of multiple BSs. One of these BSs may be selected to serve the UE. The serving BS may be selected based at least in part on various criteria such as received signal strength, received signal quality, path loss, and/or the like. Received signal quality may be quantified by a signal-to-noise-and-interference ratio (SNIR), or a reference signal received quality (RSRQ), or some other metric. The UE may operate in a dominant interference scenario in which the UE may observe high interference from one or more interfering BSs.

While aspects of the examples described herein may be associated with NR or 5G technologies, aspects of the present disclosure may be applicable with other wireless communication systems. New Radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). In aspects, NR may utilize OFDM with a CP (herein referred to as cyclic prefix OFDM or CP-OFDM) and/or SC-FDM on the uplink, may utilize CP-OFDM on the downlink and include support for half-duplex operation using time division duplexing (TDD). In aspects, NR may, for example, utilize OFDM with a CP (herein referred to as CP-OFDM) and/or discrete Fourier transform spread orthogonal frequency-division multiplexing (DFT-s-OFDM) on the uplink, may utilize CP-OFDM on the downlink and include support for half-duplex operation using time division duplexing (TDD). NR may include Enhanced Mobile Broadband (eMBB) service targeting wide bandwidth (e.g., 80 megahertz (MHz) and beyond), millimeter wave (mmW) targeting high carrier frequency (e.g., 60 gigahertz (GHz)), massive MTC (mMTC) targeting non-backward compatible MTC techniques, and/or mission critical targeting ultra reliable low latency communications (URLLC) service.

In some aspects, a single component carrier bandwidth of 100 MHz may be supported. NR resource blocks may span 12 sub-carriers with a sub-carrier bandwidth of 60 or 120 kilohertz (kHz) over a 0.1 millisecond (ms) duration. Each radio frame may include 40 slots and may have a length of 10 ms. Consequently, each slot may have a length of 0.25 ms. Each slot may indicate a link direction (e.g., DL or UL) for data transmission and the link direction for each slot may be dynamically switched. Each slot may include DL/UL data as well as DL/UL control data.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface. NR networks may include entities such central units or distributed units.

As indicated above, FIG. 4 is provided as an example. Other examples may differ from what is described with regard to FIG. 4.

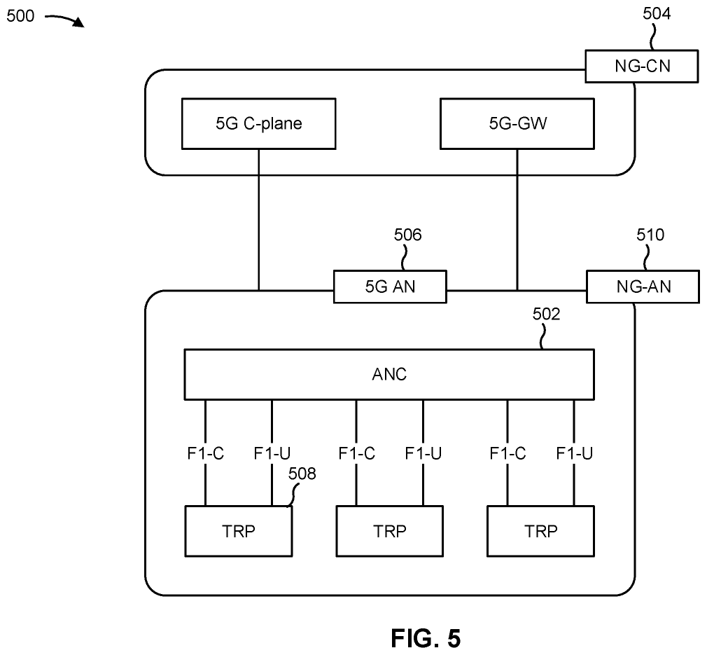

FIG. 5 illustrates an example logical architecture of a distributed RAN 500, according to aspects of the present disclosure. A 5G access node 506 may include an access node controller (ANC) 502. The ANC may be a central unit (CU) of the distributed RAN 500. The backhaul interface to the next generation core network (NG-CN) 504 may terminate at the ANC. The backhaul interface to neighboring next generation access nodes (NG-ANs) may terminate at the ANC. The ANC may include one or more TRPs 508 (which may also be referred to as BSs, NR BSs, Node Bs, 5G NBs, APs, gNB, or some other term). As described above, a TRP may be used interchangeably with “cell.”

The TRPs 508 may be a distributed unit (DU). The TRPs may be connected to one ANC (ANC 502) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of RAN 500 may be used to illustrate fronthaul definition. The architecture may be defined that support fronthauling solutions across different deployment types. For example, the architecture may be based at least in part on transmit network capabilities (e.g., bandwidth, latency, and/or jitter).

The architecture may share features and/or components with LTE. According to aspects, the next generation AN (NG-AN) 510 may support dual connectivity with NR. The NG-AN may share a common fronthaul for LTE and NR.

The architecture may enable cooperation between and among TRPs 508. For example, cooperation may be preset within a TRP and/or across TRPs via the ANC 502. According to aspects, no inter-TRP interface may be needed/present.

According to aspects, a dynamic configuration of split logical functions may be present within the architecture of RAN 500. The packet data convergence protocol (PDCP), radio link control (RLC), media access control (MAC) protocol may be adaptably placed at the ANC or TRP.

According to various aspects, a BS may include a central unit (CU) (e.g., ANC 502) and/or one or more distributed units (e.g., one or more TRPs 508).

As indicated above, FIG. 5 is provided merely as an example. Other examples may differ from what is described with regard to FIG. 5.

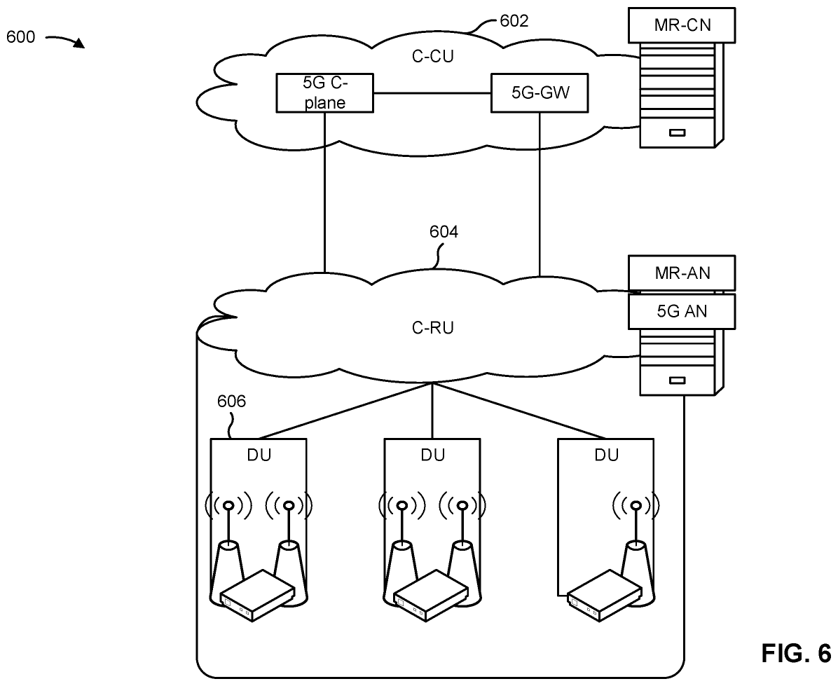

FIG. 6 illustrates an example physical architecture of a distributed RAN 600, according to aspects of the present disclosure. A centralized core network unit (C-CU) 602 may host core network functions. The C-CU may be centrally deployed. C-CU functionality may be offloaded (e.g., to advanced wireless services (AWS)), in an effort to handle peak capacity.

A centralized RAN unit (C-RU) 604 may host one or more ANC functions. Optionally, the C-RU may host core network functions locally. The C-RU may have distributed deployment. The C-RU may be closer to the network edge.

A distributed unit (DU) 606 may host one or more TRPs. The DU may be located at edges of the network with radio frequency (RF) functionality.

As indicated above, FIG. 6 is provided merely as an example. Other examples may differ from what is described with regard to FIG. 6.

In some communications systems, such as NR, a conditional handover procedure may be used for improved mobility robustness. For example, by implementing a conditional handover procedure, a network may reduce a likelihood of radio link failure for a UE and a BS in a scenario where a quality of a link between the UE and the BS degrades too quickly to apply a forward handover procedure. In the conditional handover procedure, the BS may proactively provide a conditional handover configuration to the UE. For example, the BS may provide the conditional handover configuration before a handover triggering event. In this case, the conditional handover configuration may include a configuration of a candidate target cell, an indication of a conditional handover condition to trigger a conditional handover procedure, and/or the like. When the conditional handover condition is satisfied, the UE may initiate an access procedure, such as a random access channel (RACH) access procedure to transfer to a target cell. In this way, a handover delay is reduced relative to a forward handover procedure where a source cell determines to transfer the UE to a target cell.

However, a conditional handover configuration may be statically signaled, which may result in some information in the conditional handover configuration being outdated when the UE is attempting to perform a conditional handover procedure. Moreover, when performing the conditional handover procedure, the UE may disconnect from the source cell without transmitting an acknowledgement message that the UE is handing over to the target cell. This may result in a delay in the source cell determining that a handover is occurring, a delay in the source cell determining to which target cell of a plurality of candidate target cells the UE is to transfer, and/or the like. As a result, there may be a delay in the source cell transferring a sequence number status to the target cell, forwarding data to the target cell, and/or the like.

Some aspects described herein provide conditional handover procedure signaling. For example, a UE may transmit a conditional handover execution message to a source cell to indicate that the UE is to transfer to a particular target cell of a plurality of candidate target cells. As a result, the source cell may proactively begin data forwarding to the target cell, thereby reducing a delay associated with data forwarding relative to other techniques for conditional handover procedure signaling. Moreover, before a conditional handover procedure is performed, the source cell may provide reconfiguration information to update a conditional handover configuration, which may enable the UE to update a stored cell context, a conditional handover condition, and/or the like. In this way, the UE and the source cell enable an improved conditional handover procedure by ensuring that the UE maintains updated conditional handover configuration information.

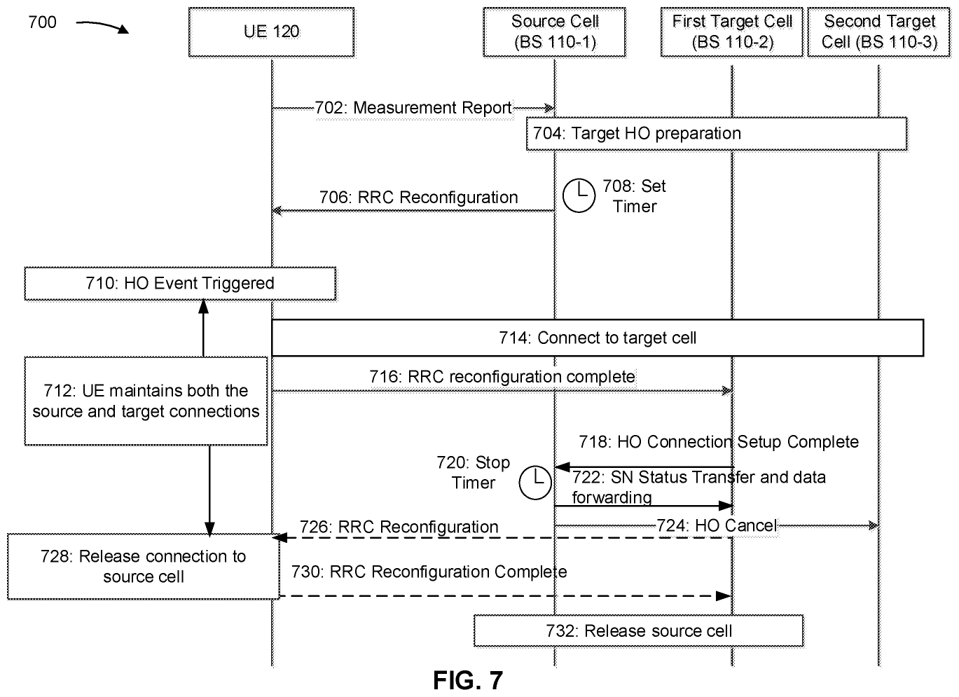

FIG. 7 is a diagram illustrating an example 700 of conditional handover procedure signaling, in accordance with various aspects of the present disclosure. As shown in FIG. 7, example 700 includes a UE 120 and a set of BSs 110. For example, the set of BSs 110 may include a source cell (e.g., BS 110-1), a first target cell (e.g., BS 110-2), a second target cell (e.g., BS 110-3), and/or the like.

As further shown in FIG. 700, and by reference number 702, UE 120 may provide a measurement report to the source cell. For example, based at least in part on the source cell transmitting a signal to UE 120, UE 120 may perform a measurement of a characteristic of the signal, and provide the measurement report to identify the measurement. In this case, UE 120 may perform a signal power measurement (e.g., a reference signal received power (RSRP)), a signal quality measurement (e.g., a reference signal received quality), and/or the like. In some aspects, UE 120 may report each measurement to the source cell. For example, UE 120 may provide the measurement report as a response to performing the measurement. In some aspects, UE 120 may report a measurement based at least in part on the measurement satisfying a threshold. For example, based at least in part on an RSRP satisfying a threshold associated with indicating that UE 120 is to transfer to another cell, UE 120 may provide the measurement report to initiate the transfer to the other cell.

As further shown in FIG. 7, and by reference number 704, the source cell may communicate with one or more candidate target cells to reserve resources for a conditional handover. For example, the source cell may transmit a message to the first target cell, the second target cell, and/or the like to reserve resources for handing over UE 120. In this case, the source cell may receive a response message (e.g., from the first target cell, from the second target cell, and/or the like), which may indicate that resources are reserved for handing over UE 120 to a target cell of a plurality of candidate target cells.

As further shown in FIG. 7, and by reference number 706, the source cell may transmit an RRC reconfiguration message to UE 120. For example, the source cell may transmit the RRC configuration to indicate an availability of a plurality of candidate target cells for a handover (e.g., the first target cell, the second target cell, and/or the like) based at least in part on communicating with the plurality of candidate target cells. In this case, the source cell may provide, via one or more information elements of the RRC reconfiguration message, information identifying the plurality of candidate target cells, information associated with connecting to the plurality of candidate target cells (e.g., a cell context, frequency information, etc.), and/or the like. Additionally, or alternatively, the source cell may provide conditional handover configuration information identifying a conditional handover condition. For example, the source cell may indicate that UE 120 is to trigger the conditional handover based at least in part on detecting that a beam quality for a beam of the source cell does not satisfy a threshold and that a beam quality for a beam of a target cell does satisfy the threshold.

In some aspects, the source cell may identify a cell group configuration for a group of candidate target cells. For example, the source cell may determine a plurality of groups of candidate target cells. In this case, each group of candidate target cells includes one or more candidate target cells, and the source cell may provide a cell group configuration message to identify information relating to a group of candidate target cells using a common information element.

As further shown in FIG. 7, and by reference number 708, the source cell may set a timer. For example, the source cell may set a conditional handover timer that may track a length of time that a conditional handover configuration associated with the RRC reconfiguration message is valid. For example, the source cell may set the timer when sending a first RRC reconfiguration message, and may reset the timer when sending a second RRC reconfiguration message (e.g., to update a conditional handover configuration). In this case, if the timer expires without a second RRC reconfiguration message being sent or without receiving signaling from UE 120 indicating a conditional handover is occurring, the source cell may send a second RRC reconfiguration message to cause UE 120 to release the conditional handover configuration of the first RRC reconfiguration message. Similarly, as described in more detail herein, the source cell may communicate with one or more candidate target cells (e.g., the first target cell, the second target cell, and/or the like) to cause the one or more candidate target cells to release reserved resources associated with enabling a conditional handover of UE 120 based at least in part on expiration of the conditional handover timer.

As further shown in FIG. 7, and by reference number 710, after receiving the RRC reconfiguration message, UE 120 may determine that a condition associated with performing a conditional handover is satisfied. For example, UE 120 may determine that a cell quality associated with the source cell does not satisfy a threshold. Additionally, or alternatively, UE 120 may determine that a beam quality of a beam used by the source cell does not satisfy a threshold. Additionally, or alternatively, UE 120 may determine that a cell quality or beam quality of at least one candidate target cell does satisfy a threshold, and may determine to initiate a conditional handover procedure.

As further shown in FIG. 7, and by reference number 712, after initiating a conditional handover procedure, UE 120 may maintain a connection to both the source cell and a target cell to which UE 120 is to transfer. For example, while UE 120 is attempting to connect to the target cell, UE 120 may maintain a connection to the source cell. In this way, UE 120 may enable a cancellation of a conditional handover. Additionally, or alternatively, UE 120 may be enabled to provide signaling to the source cell indicating that the conditional handover is occurring, thereby enabling the source cell to proactively provide data forwarding, as described in more detail herein.

As further shown in FIG. 7, and by reference number 714, UE 120 may attempt to connect to a target cell (e.g., the first target cell, the second target cell, and/or the like). For example, after selecting a target cell of a plurality of candidate target cells, UE 120 may use an access procedure (e.g., a contention-based access procedure, a random access channel (RACH)-less access procedure, a contention-less access procedure, and/or the like) to hand over to the target cell. In this case, UE 120 may communicate with the first target cell to exchange one or more messages associated with connecting UE 120 to the first target cell to use resources of the first target cell reserved for UE 120, as described above.

As further shown in FIG. 7, and by reference number 716, based at least in part on performing the access procedure, UE 120 may provide an RRC reconfiguration complete message to the first target cell to cause the first target cell to relay the RRC reconfiguration complete message to the source cell. For example, UE 120 may indicate that UE 120 is performing a conditional handover to the first target cell. In this case, UE 120 may provide the RRC reconfiguration complete message to the first target cell (e.g., for relaying to the source cell, as described below) based at least in part on determining that a link to the source cell is not associated with a threshold link quality. In this way, UE 120 avoids the RRC reconfiguration complete message being dropped during transmission to the source cell, which may result in a failure of the source cell to be notified of the conditional handover. In some aspects, UE 120 may provide a notification directly to the source cell (e.g., not via the first target cell) to indicate that UE 120 is performing the conditional handover, as described in more detail herein.

As further shown in FIG. 7, and by reference number 718, the first target cell may provide an indication to the source cell that UE 120 is performing a conditional handover procedure to transfer to the first target cell. For example, the target cell may provide a handover connection setup complete message to indicate that UE 120 is performing the conditional handover procedure to complete a conditional handover. In this case, the first target cell notifies the source cell of the conditional handover, thereby enabling the source cell to proactively begin communicating with the target cell to perform the conditional handover and release UE 120 from the source cell. In this way, the first target cell reduces a delay in notifying the source cell of the conditional handover procedure relative to another technique for conditional handover procedure signaling where the source cell is notified upon completion of the conditional handover procedure.

As further shown in FIG. 7, and by reference number 720, the source cell may stop a timer. For example, the source cell may stop a conditional handover timer based at least in part on receiving the indication that UE 120 is performing the conditional handover procedure. In another case, based at least in part on the timer expiring before the source cell is notified of the conditional handover, the source cell may determine that a conditional handover is not occurring, and may reset a conditional handover configuration of UE 120 and cause one or more candidate target cells to release resources reserved for UE 120, as described in more detail herein.

As further shown in FIG. 7, and by reference number 722, the source cell may transfer a sequence number (SN) status to the first target cell. For example, based at least in part on receiving the indication from the first target cell that UE 120 is handing over to the first target cell, UE 120 may provide the sequence number status for UE 120 to the first target cell to enable UE 120 and the first target cell to establish a connection for communication of data traffic. In this case, the sequence number status may include an uplink packet data convergence protocol (PDCP) status, a downlink sequence number, and/or the like for UE 120. In some aspects, the source cell may stop data transmission and/or reception, and may forward data to the first target node. For example, the source cell may proactively forward data to the first target node for UE 120 to avoid dropping of data during the conditional handover procedure.

As further shown in FIG. 7, and by reference number 724, the source cell may provide a handover cancellation message to the second target cell. For example, based at least in part on determining that UE 120 is handing over to first target cell, the source cell may indicate to the second target cell that UE 120 is not to hand over to the second target cell. In this case, the second target cell may release resources reserved for UE 120, as described above.

As further shown in FIG. 7, and by reference number 726, the first target cell may transmit an RRC reconfiguration message to UE 120. For example, the first target cell may transmit the RRC reconfiguration message to trigger UE 120 to release a connection to the source cell. In this case, the first target cell configures UE 120 and confirms that the access procedure is successful in transferring UE 120 to the first target cell.

As further shown in FIG. 7, and by reference number 728, based at least in part on receiving the RRC reconfiguration message, UE 120 may release a connection to the source cell. For example, UE 120 may release the connection to the source cell, thereby completing the handover from the source cell to the first target cell.

As further shown in FIG. 7, and by reference number 730, UE 120 may provide a response message to the RRC reconfiguration message from the first target cell. For example, after receiving the RRC reconfiguration message and releasing the connection to the source cell, UE 120 may provide a RRC reconfiguration complete message to the first target cell to indicate that UE 120 has updated an RRC configuration and released a connection to the source cell. In this case, the first target cell may switch a user plane for UE 120 (e.g., by communicating with a user-plane function, an access and mobility management function (AMF)) to complete the handover from the source cell to the first target cell.

As further shown in FIG. 7, and by reference number 732, based at least in part on UE 120 releasing the connection to the source cell and providing the response to the RRC reconfiguration message, the first target cell and the source cell may communicate to release the source cell. For example, the source cell may release resources reserved for UE 120 based at least in part on determining that UE 120 has completed a handover to the first target cell.

As indicated above, FIG. 7 is provided as an example. Other examples may differ from what is described with respect to FIG. 7.

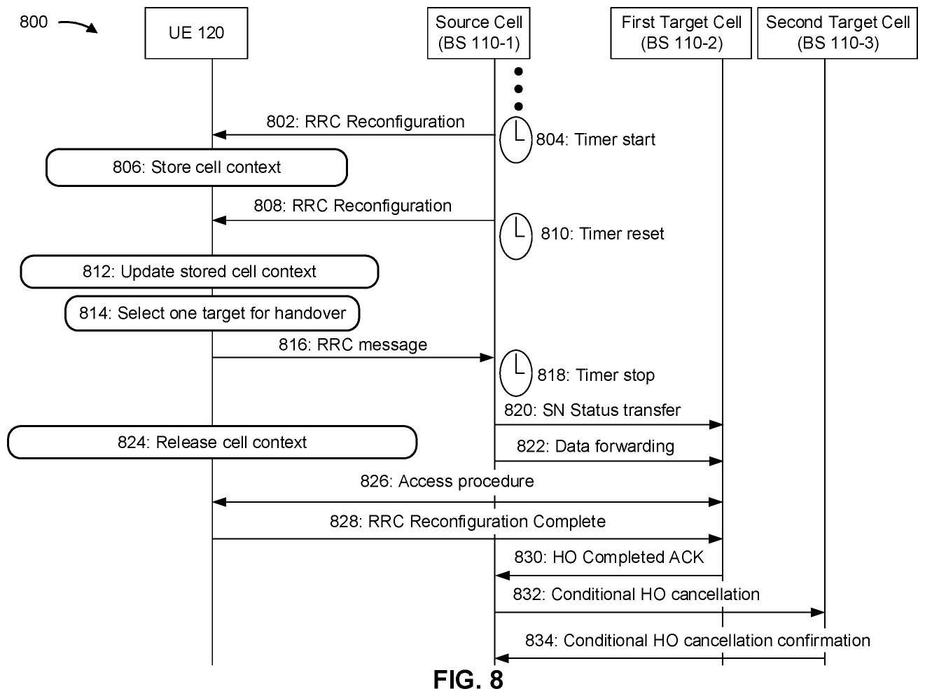

FIG. 8 is a diagram illustrating an example 800 of conditional handover procedure signaling, in accordance with various aspects of the present disclosure. As shown in FIG. 8, example 800 includes a UE 120 and a set of BSs 110. For example, the set of BSs 110 may include a source cell (e.g., BS 110-1), a first target cell (e.g., BS 110-2), a second target cell (e.g., BS 110-3), and/or the like.

As further shown in FIG. 8, and by reference numbers 802 and 804, the source cell may provide an RRC reconfiguration message to UE 120, and may start a timer associated with the RRC reconfiguration message. For example, the source cell may start a conditional handover timer for a conditional handover configuration, as described above. In this case, the source cell may transmit the RRC reconfiguration message after providing a measurement control message to UE 120, receiving a measurement report from UE 120, performing a handover decision based at least in part on the measurement report, communicating with one or more candidate target cells to initiate admission control procedures, and/or the like, as described above. In some aspects, the source cell may provide information identifying a conditional handover condition.

In some aspects, the source cell may provide a group configuration for a set of candidate target cells that the source cell has assigned to a cell group. For example, the source cell may provide information identifying a conditional handover configuration for a plurality of candidate target cells in a cell group using a single information element. In this case, the group configuration may include a cell list, a group configuration, a cell-specific configuration (e.g., a delta value indicating an offset of a parameter value of a particular candidate target cell's configuration relative to a corresponding parameter value of the group configuration), and/or the like.

In some aspects, the source cell may assign a candidate target cell to a cell group. For example, the source cell may determine that a candidate target cell is to be included in a cell group, and may use delta signaling to add the candidate target cell to the cell group. In this case, the source cell may transmit the delta signaling to UE 120 to add the candidate target cell to the cell group to enable UE 120 to associate information of a group configuration to the candidate target cell when the source cell provides the information of the group configuration. Similarly, the source cell may use delta signaling to remove a candidate target cell from a cell group. Based at least in part on using cell groups to assign a common set of parameters to a plurality of candidate target cells, UE 120 may reduce signaling relative to providing separate signaling for each candidate target cell.

As further shown in FIG. 8, and by reference number 806, based at least in part on receiving the RRC reconfiguration message, UE 120 may store a cell context for a set of candidate target cells. For example, UE 120 may store conditional handover configuration information associated with handing over to the first target cell, the second target cell, and/or the like. In this case, UE 120 may store frequency information, channel information, modulation information, and/or the like. In some aspects, UE 120 may store a group configuration for a group of candidate target cells, information identifying a conditional handover condition for triggering a conditional handover, and/or the like.

In some aspects, UE 120 may determine whether to apply the RRC reconfiguration message. For example, when the RRC reconfiguration message relates to a candidate target cell, UE 120 may determine to apply the RRC reconfiguration message when performing a conditional handover. In some aspects, UE 120 may determine to apply the RRC reconfiguration message only after a timer expires (e.g., a RACH-less access procedure timer of UE 120). In some aspects, UE 120 may determine to apply the RRC reconfiguration message on reset of a timer. Additionally, or alternatively, when the RRC reconfiguration message relates to the source cell, UE 120 may determine to perform delta signaling to update an RRC configuration for the source cell.

As further shown in FIG. 8, and by reference numbers 808 and 810, the source cell may transmit another RRC reconfiguration message to provide updated information to UE 120. For example, the source cell may transmit the other RRC reconfiguration message to update a configuration of one or more candidate target cells. Additionally, or alternatively, the source cell may provide an updated conditional handover condition. In this case, the source cell may reset the conditional handover timer based at least in part on transmitting another RRC reconfiguration message. In this way, the source cell updates a conditional handover configuration for UE 120, thereby ensuring that information UE 120 uses to determine whether to perform a conditional handover, to select a candidate target cell to which to transfer, and/or the like is up-to-date. This may improve a likelihood of success of a conditional handover relative to other techniques for conditional handovers where a conditional handover configuration is not updated periodically.

As further shown in FIG. 8, and by reference number 812, UE 120 may update stored information based at least in part on the other RRC configuration message. For example, UE 120 may store an updated configuration of a candidate target cell, an updated cell context, an updated group configuration, an updated conditional handover condition, and/or the like.

As further shown in FIG. 8, and by reference number 814, UE 120 may select a candidate target cell for a conditional handover. For example, UE 120 may determine that the updated conditional handover condition is satisfied, and may select, for example, the first target cell based at least in part on a candidate target cell selection procedure. In this case, UE 120 may select the first target cell based at least in part on a cell quality, an index value, a priority, a beam quality, and/or the like. In some aspects, UE 120 may remain connected to the source cell when selecting a candidate target cell and when performing a subsequent access procedure with the candidate target cell, as described above. For example, UE 120 may maintain a UE context of the source cell, which may enable UE 120 to communicate with the source cell, such as to provide an indication that UE 120 is performing a conditional handover. This may enable the source cell to proactively begin communicating with the candidate target cell to transfer UE 120 to the candidate target cell, thereby improving conditional handover procedures, as described herein.

In another example, in some aspects, UE 120 may determine not to perform a conditional handover. For example, UE 120 may determine that a conditional handover condition is not satisfied, that a link quality associated with the source cell has improved to satisfy a threshold, and/or the like, and may determine not to handover to another cell. In this case, UE 120 may transmit signaling to the source cell to request cancellation of the conditional handover, such as via an event type A1 signal, an RRC signaling message, and/or the like.

As further shown in FIG. 8, and by reference numbers 816 and 818, UE 120 may provide an RRC message to the source cell, and the source cell may stop the conditional handover timer. For example, based at least in part on receiving the RRC message indicating that UE 120 is performing the conditional handover, the source cell may reset the conditional handover timer for resetting a conditional handover configuration. In this case, based at least in part on UE 120 providing the RRC message to the source cell, UE 120 enables the source cell to begin communicating with the first target cell to enable the conditional handover, as described in more detail herein.

In some aspects, the source cell may stop sending data to UE 120 (e.g., when UE 120 does not support mobile broadband (MBB)), which may reduce utilization of network resources. Additionally, or alternatively, the source cell may start a RACH-less timer (e.g., when UE 120 is configured to use a RACH-less access procedure) to enable an access procedure to be performed. For example, the source cell may start the RACH-less timer as a response to receiving a notification that UE 120 is performing the conditional handover and based at least in part on determining that UE 120 is to use the RACH-less access procedure.

In some aspects, UE 120 may provide a notification of the conditional handover to the source cell via an RRC message, as described above. Additionally, or alternatively, UE 120 may provide a layer 1 (L1) signaling message, a media access control (MAC) control element (CE) message, a layer 3 (L3) signaling message, and/or the like to indicate that UE 120 is performing the conditional handover. In some aspects, the source cell may provide an RRC reconfiguration message to cause UE 120 to release information relating to a conditional handover, and to fallback to a legacy handover, as described in more detail below.

In this way, UE 120 reduces an amount of time to complete the conditional handover, a likelihood of data being dropped during the conditional handover, and/or the like relative to another technique where UE 120 disconnects from the source cell and the source cell is not notified of the conditional handover until after UE 120 successfully connects to a target cell.

As further shown in FIG. 8, and by reference numbers 820 and 822, the source cell may communicate with the first target cell to provide a sequence number status, to forward data, and/or the like. For example, the source cell may transfer the sequence number status and perform data forwarding as a response to receiving the RRC message from UE 120, thereby reducing a delay relative to waiting to receive a message from the first target cell that UE 120 has successfully connected to the first target cell.

As further shown in FIG. 8, and by reference numbers 824, 826, and 828, UE 120 may release context information relating to other candidate target cells (e.g., the second target cell), may communicate with the first target cell to perform an access procedure, and may provide an RRC configuration complete message to the first target cell based at least in part on successful completion of the access procedure. For example, UE 120 may perform a contention-less access procedure, a RACH-less access procedure, a contention-based access procedure, and/or the like to transfer to the first target cell, as described above.

As further shown in FIG. 8, and by reference numbers 830, 832, and 834, the first target cell may provide an acknowledgement message to the source cell indicating that UE 120 has successfully transferred to the first target cell, and the source cell may provide a conditional handover cancellation message to the second target cell and receive a response message. For example, based at least in part on determining that the conditional handover is complete, the source cell may indicate to the second target cell that the second target cell may release resources reserved for UE 120, as described above.

As indicated above, FIG. 8 is provided as an example. Other examples may differ from what is described with respect to FIG. 8.

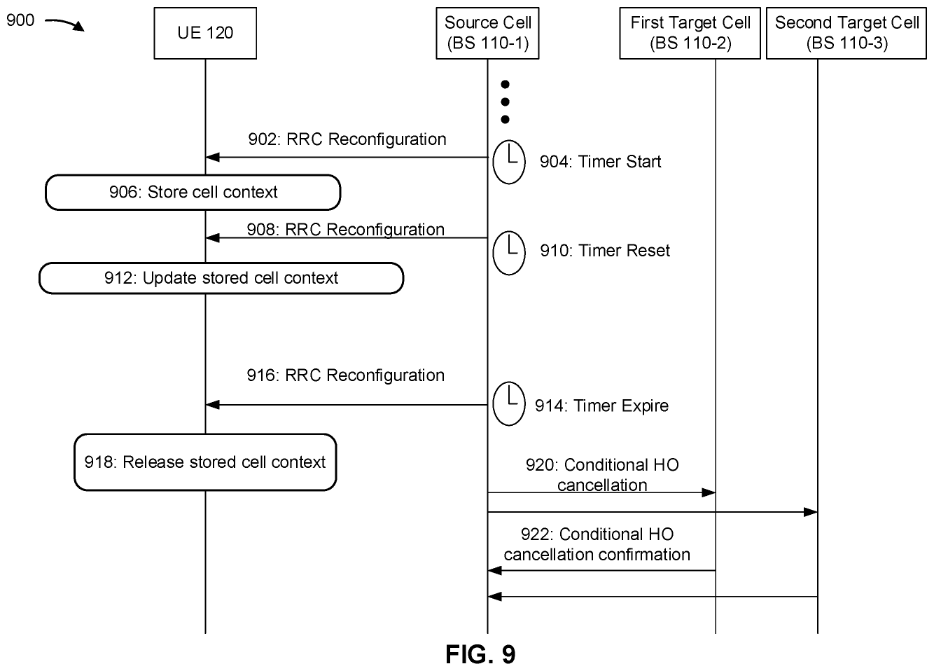

FIG. 9 is a diagram illustrating an example 900 of conditional handover procedure signaling, in accordance with various aspects of the present disclosure. As shown in FIG. 9, example 900 includes a UE 120 and a set of BSs 110. For example, the set of BSs 110 may include a source cell (e.g., BS 110-1), a first target cell (e.g., BS 110-2), a second target cell (e.g., BS 110-3), and/or the like.

As further shown in FIG. 9, and by reference numbers 902 and 904, the source cell may provide an RRC reconfiguration message to UE 120, and may start a timer associated with resetting a conditional handover configuration. For example, the source cell may provide the RRC reconfiguration message to identify the conditional handover configuration, a conditional handover condition, a cell context of a candidate target cell (e.g., the first target cell, the second target cell, and/or the like), a group configuration, and/or the like as described above. In this case, the source cell may provide the RRC reconfiguration message based at least in part on RRC reconfiguration message after providing a measurement control message to UE 120, receiving a measurement report from UE 120, performing a handover decision based at least in part on the measurement report, communicating with one or more candidate target cells to initiate admission control procedures, and/or the like, as described above.

As further shown in FIG. 9, and by reference number 906, based at least in part on receiving the RRC reconfiguration message, UE 120 may store a cell context for a set of candidate target cells, as described above. For example, UE 120 may store information associated with handing over to the first target cell, the second target cell, and/or the like.

As further shown in FIG. 9, and by reference numbers 908 and 910, the source cell may transmit another RRC reconfiguration message to provide updated information to UE 120. For example, the source cell may transmit the other RRC reconfiguration message to update a configuration of one or more candidate target cells. Additionally, or alternatively, the source cell may provide an updated conditional handover condition. In this case, the source cell may reset the conditional handover timer based at least in part on transmitting another RRC reconfiguration message.

As further shown in FIG. 9, and by reference number 912, UE 120 may update stored information based at least in part on the other RRC configuration message, as described above. For example, UE 120 may store an updated configuration of a candidate target cell, an updated group configuration, an updated conditional handover condition, and/or the like.

As further shown in FIG. 9, and by reference numbers 914 and 916, the conditional handover timer may expire, and the source cell may provide an RRC reconfiguration message. For example, based at least in part on UE 120 not initiating a conditional handover within a threshold period of time tracked by the conditional handover timer (e.g., based at least in part on UE 120 determining that the updated conditional handover condition is not satisfied), the source cell may determine to cancel a conditional handover procedure. In this case, the source cell may provide the RRC reconfiguration message to indicate that the conditional handover procedure is cancelled, and to cause UE 120 to release a cell context associated with one or more candidate target cells.

As further shown in FIG. 9, and by reference number 918, based at least in part on receiving the RRC reconfiguration message, UE 120 may release the cell context associated with the one or more candidate target cells. In this case, UE 120 may determine that the conditional handover procedure is ended, and may begin the conditional handover procedure again after providing a measurement report, receiving another RRC reconfiguration message, and/or the like.

As further shown in FIG. 9, and by reference numbers 920 and 922, the source cell may provide conditional handover cancellation messages to the set of candidate target cells, and may receive conditional handover cancellation confirmation messages. For example, the source cell may provide the conditional handover cancellation messages to the first target cell, the second target cell, and/or the like to cause the first target cell, the second target cell, and/or the like to release resources reserved for UE 120 to perform a conditional handover. In this case, based at least in part on releasing the resources, the first target cell, the second target cell, and/or the like may provide the conditional handover cancellation confirmation messages as responses.

As indicated above, FIG. 9 is provided as an example. Other examples may differ from what is described with respect to FIG. 9.

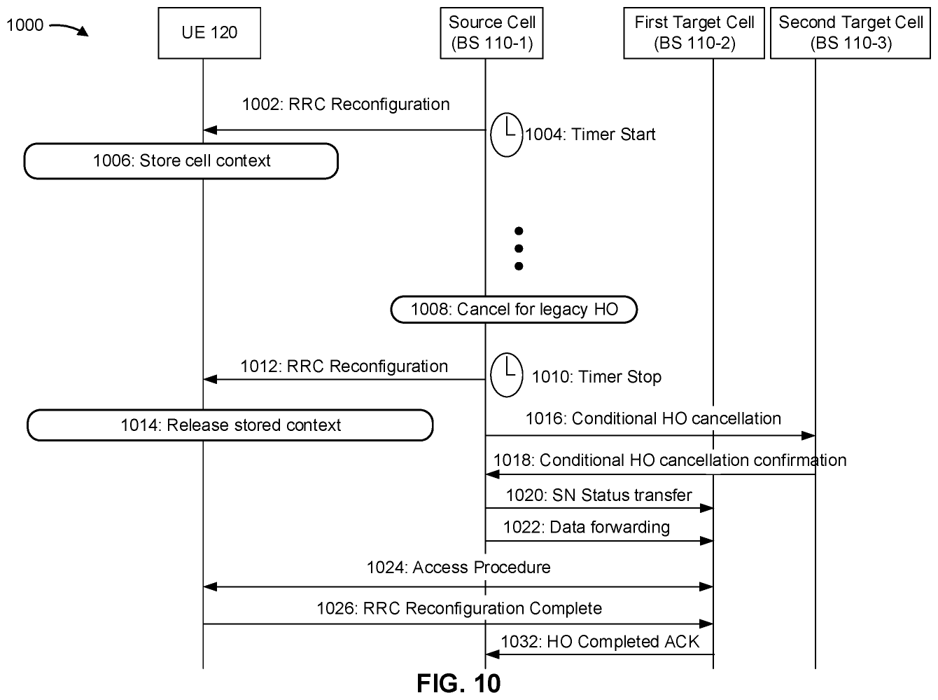

FIG. 10 is a diagram illustrating an example 1000 of conditional handover procedure signaling, in accordance with various aspects of the present disclosure. As shown in FIG. 10, example 1000 includes a UE 120 and a set of BSs 110. For example, the set of BSs 110 may include a source cell (e.g., BS 110-1), a first target cell (e.g., BS 110-2), a second target cell (e.g., BS 110-3), and/or the like.

As further shown in FIG. 10, and by reference numbers 1002 and 1004, the source cell may provide an RRC reconfiguration message to UE 120, and may start a timer associated with resetting a conditional handover configuration. For example, the source cell may provide the RRC reconfiguration message to identify the conditional handover configuration, a conditional handover condition, a cell context of a candidate target cell (e.g., the first target cell, the second target cell, and/or the like), a group configuration, and/or the like as described above.

As further shown in FIG. 10, and by reference number 1006, based at least in part on receiving the RRC reconfiguration message, UE 120 may store a cell context for a set of candidate target cells, as described above. For example, UE 120 may store information associated with handing over to the first target cell, the second target cell, and/or the like, as described above.

As further shown in FIG. 10, and by reference number 1008, the source cell may determine to cancel the conditional handover procedure, and to start a legacy handover procedure. For example, based at least in part on the source cell determining that a particular candidate target cell (e.g., the first target cell) is associated with a threshold channel quality metric, the source cell may determine to immediately trigger a handover using the legacy handover procedure rather than waiting for UE 120 to trigger a conditional handover. In this case, the source cell may transmit an RRC reconfiguration message to cause UE 120 to fall back to the legacy handover procedure.

As further shown in FIG. 10, and by reference numbers 1010 and 1012, the source cell may stop a conditional handover timer, and may provide an RRC reconfiguration message to UE 120. For example, based at least in part on determining to cancel the conditional handover procedure and to start the legacy handover procedure, the source cell may end the conditional handover timer and provide the RRC reconfiguration message to UE 120. In this case, the source cell provides the RRC reconfiguration message to cancel the conditional handover procedure, and cause UE 120 to release a stored cell context associated with one or more candidate target cells, as described above.

As further shown in FIG. 10, and by reference number 1014, based at least in part on receiving the RRC reconfiguration message, UE 120 may release the cell context associated with the one or more candidate target cells. In this case, UE 120 may determine that the conditional handover procedure is cancelled, and may begin an access procedure for a legacy handover procedure based at least in part on information included in the RRC reconfiguration message.

As further shown in FIG. 10, and by reference numbers 1016 and 1018, the source cell may provide a conditional handover cancellation message to one or more candidate target cells, and may receive a conditional handover cancellation confirmation message. For example, the source cell may provide the conditional handover cancellation messages to the second target cell to cause the second target cell to release resources reserved for UE 120 to perform a conditional handover. In this case, based at least in part on releasing the resources, the second target cell may provide the conditional handover cancellation confirmation messages as responses.

As further shown in FIG. 10, and by reference numbers 1020 and 1022, the source cell may transfer a sequence number status and perform data forwarding in accordance with a legacy handover procedure. For example, the source cell may provide the sequence number status and forward data to the first target cell. In this case, based at least in part on the source cell not providing a conditional handover cancellation message to the first target cell, the first target cell retains reserved resources for UE 120 that may be used for the legacy handover procedure rather than the conditional handover procedure.

As further shown in FIG. 10, and by reference numbers 1024 and 1026, UE 120 may communicate with the first target cell to perform an access procedure, and may provide an RRC configuration complete message to the first target cell based at least in part on successful completion of the access procedure. For example, UE 120 may perform a contention-less access procedure, a RACH-less access procedure, a contention-based access procedure, and/or the like to transfer to the first target cell, as described above, in accordance with a legacy handover procedure.

As further shown in FIG. 10, and by reference number 1032, the first target cell may provide an acknowledgement message to the source cell indicating that UE 120 has successfully transferred to the first target cell, as described above.

As indicated above, FIG. 10 is provided as an example. Other examples may differ from what is described with respect to FIG. 10.

FIG. 11 is a diagram illustrating an example process 1100 performed, for example, by a UE, in accordance with various aspects of the present disclosure. Example process 1100 is an example where a UE (e.g., UE 120) performs conditional handover procedure signaling.

As shown in FIG. 11, in some aspects, process 1100 may include determining to perform a conditional handover procedure to transfer from a source cell to a target cell of a plurality of candidate target cells (block 1110). For example, the UE (e.g., using controller/processor 280 and/or the like) may determine to perform a conditional handover procedure to transfer from a source cell to a target cell of a plurality of candidate target cells, as described in more detail above.

As shown in FIG. 11, in some aspects, process 1100 may include transmitting, to the source cell, a conditional handover execution message to indicate the conditional handover procedure to transfer from the source cell to the target cell based at least at least in part on determining to perform the conditional handover procedure (block 1120). For example, the UE (e.g., using controller/processor 280, transmit processor 264, TX MIMO processor 266, MOD 254, antenna 252, and/or the like) may transmit, to the source cell, a conditional handover execution message to indicate the conditional handover procedure to transfer from the source cell to the target cell based at least at least in part on determining to perform the conditional handover procedure, as described in more detail above.

As shown in FIG. 11, in some aspects, process 1100 may include communicating with the target cell to transfer to the target cell based at least in part on determining to perform the conditional handover procedure (block 1130). For example, the UE (e.g., using antenna 252, DEMOD 254, MIMO detector 256, receive processor 258, controller/processor 280, transmit processor 264, TX MIMO processor 266, MOD 254, antenna 252, and/or the like) may communicate with the target cell to transfer to the target cell based at least in part on determining to perform the conditional handover procedure, as described in more detail above.

Process 1100 may include additional aspects, such as any single aspect and/or any combination of aspects described below and/or in connection with one or more other processes described elsewhere herein.

In a first aspect, the UE is configured to receive, from the source cell, a configuration message identifying a set of cell configurations and a set of conditional handover conditions for the plurality of candidate target cells. In a second aspect, alone or in combination with the first aspect, the set of cell configurations includes a plurality of cell group configurations for each candidate target cell of the plurality of candidate target cells. In a third aspect, alone or in combination with one or more of the first and second aspects, the UE is configured to receive a delta signaling message to add a particular cell group configuration to the plurality of cell group configurations or to remove the particular cell group configuration from the plurality of cell group configurations. In a fourth aspect, alone or in combination with one or more of the first through third aspects, a cell configuration of the set of cell configurations and a corresponding conditional handover condition of the set of conditional handover conditions is provided via an information element. In a fifth aspect, alone or in combination with one or more of the first through fourth aspects, the configuration message is a radio resource control (RRC) message.

In a sixth aspect, alone or in combination with one or more of the first through fifth aspects, the configuration message identifies at least one of a cell list, a group configuration, a cell-specific configuration, a cell physical cell identity, or a cell-specific dedicated configuration. In a seventh aspect, alone or in combination with one or more of the first through sixth aspects, the UE is configured to provide the conditional handover execution message via at least one of: a layer 1 (L1) signaling message, a media access control (MAC) control element (CE) message, or a layer 3 (L3) signaling message. In an eighth aspect, alone or in combination with one or more of the first through seventh aspects, the UE is configured to apply a configuration of a configuration message from the source cell when executing a handover based at least in part on the configuration message relating to a candidate target cell of the plurality of candidate target cells.

In a ninth aspect, alone or in combination with one or more of the first through eighth aspects, the UE is configured to apply a configuration of a configuration message from the source cell before a handover to update a configuration for the source cell based at least in part on the configuration message relating to the source cell. In a tenth aspect, alone or in combination with one or more of the first through ninth aspects, the UE is configured to determine whether a configuration message relates to the source cell or to a candidate target cell, of the plurality of candidate target cells, based at least in part on an information element parameter. In an eleventh aspect, alone or in combination with one or more of the first through tenth aspects, the UE is configured to release a configuration of a configuration message from the source cell for the target cell before expiration of a timer, and to at least one of: release a conditional handover configuration, or discard a conditional handover configuration.

In a twelfth aspect, alone or in combination with one or more of the first through eleventh aspects, the UE is configured to update a configuration of a configuration message from the source cell for the target cell before expiration of a timer, and the UE is configured to reset the timer, store a cell context, update the cell context based at least in part on delta signaling, apply the cell context in connection with performing a handover, and discard other cell contexts for other cells in connection with performing the handover. In a thirteenth aspect, alone or in combination with one or more of the first through twelfth aspects, the UE is configured to fall back to a non-conditional handover based at least in part on receiving a measurement report during a conditional handover evaluation period.

In a fourteenth aspect, alone or in combination with one or more of the first through thirteenth aspects, the UE is configured to receive a non-conditional handover command from the source cell, and the UE is configured to at least one of: release a conditional handover configuration, discard a conditional handover configuration, stop a random access channel (RACH)-less timer, or perform a non-conditional handover in accordance with the non-conditional handover command. In a fifteenth aspect, alone or in combination with one or more of the first through fourteenth aspects, the UE is configured to trigger a random access channel (RACH)-less timer in connection with transmitting the conditional handover execution message.

In a sixteenth aspect, alone or in combination with one or more of the first through fifteenth aspects, the UE is configured to transmit a conditional handover cancellation message during a conditional handover evaluation period and before performing the conditional handover procedure. In a seventeenth aspect, alone or in combination with one or more of the first through sixteenth aspects, the UE is configured to transmit the conditional handover cancellation message based at least in part on a cell quality determination associated with the source cell. In an eighteenth aspect, alone or in combination with one or more of the first through seventeenth aspects, the UE is configured to transmit the conditional handover cancellation message using a measurement reporting event message or a radio resource control (RRC) message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a source cell, in accordance with various aspects of the present disclosure. Example process 1200 is an example where a source cell (e.g., BS 110) performs conditional handover procedure signaling.

As shown in FIG. 12, in some aspects, process 1200 may include providing, to a user equipment (UE), a configuration message identifying a set of cell configurations for a plurality of candidate target cells and a set of conditional handover conditions for the plurality of candidate target cells (block 1210). For example, the source cell (e.g., using controller/processor 240, transmit processor 220, TX MIMO processor 230, MOD 232, antenna 234, and/or the like) may provide, to a user equipment (UE), a configuration message identifying a set of cell configurations for a plurality of candidate target cells and a set of conditional handover conditions for the plurality of candidate target cells, as described in more detail above.

As shown in FIG. 12, in some aspects, process 1200 may include receiving, from the UE, a conditional handover execution message to indicate a conditional handover procedure to transfer from the source cell to a target cell of the plurality of candidate target cells after providing the configuration message (block 1220). For example, the source cell (e.g., using antenna 234, DEMOD 232, MIMO detector 236, receive processor 238, controller/processor 240, and/or the like) may receive, from the UE, a conditional handover execution message to indicate a conditional handover procedure to transfer from the source cell to a target cell of the plurality of candidate target cells after providing the configuration message, as described in more detail above.

As shown in FIG. 12, in some aspects, process 1200 may include communicating with the target cell to enable the UE to transfer to the target cell based at least in part on receiving the conditional handover execution message (block 1230). For example, the source cell (e.g., using antenna 234, DEMOD 232, MIMO detector 236, receive processor 238, controller/processor 240, transmit processor 220, TX MIMO processor 230, MOD 232, antenna 234, and/or the like) may communicate with the target cell to enable the UE to transfer to the target cell based at least in part on receiving the conditional handover execution message, as described in more detail above.

Process 12000 may include additional aspects, such as any single aspect and/or any combination of aspects described below and/or in connection with one or more other processes described elsewhere herein.

In a first aspect, the set of cell configurations includes a plurality of cell group configurations for each candidate target cell of the plurality of candidate target cells. In a second aspect, alone or in combination with the first aspect, the source cell is configured to provide a delta signaling message to add a particular cell group configuration to the plurality of cell group configurations or to remove the particular cell group configuration from the plurality of cell group configurations.

In a third aspect, alone or in combination with one or more of the first and second aspects, the source cell is configured to provide a cell configuration, of the set of cell configurations, and a corresponding conditional handover condition, of the set of conditional handover conditions, via an information element. In a fourth aspect, alone or in combination with one or more of the first through third aspects, the configuration message is a radio resource control (RRC) message. In a fifth aspect, alone or in combination with one or more of the first through fourth aspects, the source cell is configured to group one or more candidate target cells, of the plurality of candidate target cells, into one or more configuration groups, and the configuration message identifies, for a configuration group of the one or more configuration groups, at least one of: a cell list, a group configuration, a cell-specific configuration, a cell physical cell identity, or a cell-specific dedicated configuration.

In a sixth aspect, alone or in combination with one or more of the first through fifth aspects, the source cell is configured to receive the conditional handover execution message via at least one of: a layer 1 (L1) signaling message, a media access control (MAC) control element (CE) message, or a layer 3 (L3) signaling message. In a seventh aspect, alone or in combination with one or more of the first through sixth aspects, the source cell is configured to receive a confirmation that the conditional handover procedure is complete from the UE or from the target cell. In an eighth aspect, alone or in combination with one or more of the first through seventh aspects, the source cell is configured to release reserved resources of the plurality of candidate target cells based at least in part on not receiving the conditional handover execution message before expiration of a conditional handover timer and to provide, to the UE, a reconfiguration information message to indicate the release of the reserved resources and cause a fallback to a non-conditional handover procedure.

In a ninth aspect, alone or in combination with one or more of the first through eighth aspects, the source cell is configured to start a conditional handover timer to track a conditional handover evaluation period in connection with transmitting the configuration message with a conditional handover configuration. In a tenth aspect, alone or in combination with one or more of the first through ninth aspects, the source cell is configured to reset the conditional handover timer in connection with transmitting a subsequent configuration message with the conditional handover configuration after the configuration message. In an eleventh aspect, alone or in combination with one or more of the first through tenth aspects, the source cell is configured to send a reconfiguration information message to the UE to release the conditional handover configuration based at least in part on a conditional handover execution message not being received before expiration of a conditional handover time period.

In a twelfth aspect, alone or in combination with one or more of the first through eleventh aspects, the source cell is configured to perform data forwarding to the target cell based at least in part on receiving the conditional handover execution message from the UE to enable the UE to transfer to the target cell. In a thirteenth aspect, alone or in combination with one or more of the first through twelfth aspects, the source cell is configured to perform data forwarding to the target cell based at least in part on receiving a conditional handover complete message from the target cell to enable the UE to transfer to the target cell. In a fourteenth aspect, alone or in combination with one or more of the first through thirteenth aspects, the source cell is configured to trigger a fallback to a non-conditional handover upon reception of a measurement report from the UE during a conditional handover evaluation period.

In a fifteenth aspect, alone or in combination with one or more of the first through fourteenth aspects, the source cell is configured to send a non-conditional handover command to the UE to trigger a fall back to a non-conditional handover. In a sixteenth aspect, alone or in combination with one or more of the first through fifteenth aspects, the source cell is configured to receive a conditional handover cancellation message from the UE during a conditional handover evaluation period and before the conditional handover procedure. In a seventeenth aspect, alone or in combination with one or more of the first through sixteenth aspects, the source cell is configured to receive the conditional handover cancellation message via a measurement reporting event message or a radio resource control message.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
determining to perform a conditional handover procedure to transfer from a source cell to a target cell of a plurality of candidate target cells;
transmitting, to the source cell, a conditional handover execution message to indicate the conditional handover procedure to transfer from the source cell to the target cell based at least at least in part on determining to perform the conditional handover procedure; and
communicating with the target cell to transfer to the target cell based at least in part on determining to perform the conditional handover procedure.

2. The method of claim 1, wherein the UE is configured to receive, from the source cell, a configuration message identifying a set of cell configurations and a set of conditional handover conditions for the plurality of candidate target cells,
wherein the set of cell configurations includes a plurality of cell group configurations for each candidate target cell of the plurality of candidate target cells,
wherein the UE is configured to receive a delta signaling message to add a particular cell group configuration to the plurality of cell group configurations or to remove the particular cell group configuration from the plurality of cell group configurations.

3. (canceled)

4. (canceled)

5. The method of claim 2, wherein a cell configuration of the set of cell configurations and a corresponding conditional handover condition of the set of conditional handover conditions is provided via an information element.

6. The method of claim 2, wherein the configuration message is a radio resource control (RRC) message.

7. The method of claim 2, wherein the configuration message identifies at least one of a cell list, a group configuration, a cell-specific configuration, a cell physical cell identity, or a cell-specific dedicated configuration.

8. The method of claim 1, wherein the UE is configured to provide the conditional handover execution message via at least one of:
a layer 1 (L1) signaling message,
a media access control (MAC) control element (CE) message, or
a layer 3 (L3) signaling message.

9. The method of claim 1, wherein the UE is configured to apply a configuration of a configuration message from the source cell when executing a handover based at least in part on the configuration message relating to a candidate target cell of the plurality of candidate target cells and to update a configuration for the source cell based at least in part on the configuration message relating to the source cell.

10. (canceled)

11. The method of claim 1, wherein the UE is configured to determine whether a configuration message relates to the source cell or to a candidate target cell, of the plurality of candidate target cells, based at least in part on an information element parameter.

12. The method of claim 1, wherein the UE is configured to release a configuration of a configuration message from the source cell for the target cell before expiration of a timer, and to at least one of:
release a conditional handover configuration, or
discard a conditional handover configuration.

13. The method of claim 1, wherein the UE is configured to update a configuration of a configuration message from the source cell for the target cell before expiration of a timer, and
wherein the UE is configured to reset the timer, store a cell context, update the cell context based at least in part on delta signaling, apply the cell context in connection with performing a handover, and discard other cell contexts for other cells in connection with performing the handover.

14. The method of claim 1, wherein the UE is configured to fall back to a non-conditional handover based at least in part on receiving a measurement report during a conditional handover evaluation period.

15. The method of claim 1, wherein the UE is configured to receive a non-conditional handover command from the source cell, and
wherein the UE is configured to at least one of:
release a conditional handover configuration,
discard a conditional handover configuration,
stop a random access channel (RACH)-less timer, or
perform a non-conditional handover in accordance with the non-conditional handover command.

16. The method of claim 1, wherein the UE is configured to trigger a random access channel (RACH)-less timer in connection with transmitting the conditional handover execution message.

17. The method of claim 1, wherein the UE is configured to transmit a conditional handover cancellation message during a conditional handover evaluation period and before performing the conditional handover procedure,
wherein the UE is configured to transmit the conditional handover cancellation message based at least in part on a cell quality determination associated with the source cell, and
wherein the UE is configured to transmit the conditional handover cancellation message using a measurement reporting event message or a radio resource control (RRC) message.

18. (canceled)

19. (canceled)

20. A method of wireless communication performed by a source cell, comprising:
providing, to a user equipment (UE), a configuration message identifying a set of cell configurations for a plurality of candidate target cells and a set of conditional handover conditions for the plurality of candidate target cells;
receiving, from the UE, a conditional handover execution message to indicate a conditional handover procedure to transfer from the source cell to a target cell of the plurality of candidate target cells after providing the configuration message; and
communicating with the target cell to enable the UE to transfer to the target cell based at least in part on receiving the conditional handover execution message.

21. The method of claim 20, wherein the set of cell configurations includes a plurality of cell group configurations for each candidate target cell of the plurality of candidate target cells, and
wherein the source cell is configured to provide a delta signaling message to add a particular cell group configuration to the plurality of cell group configurations or to remove the particular cell group configuration from the plurality of cell group configurations.

22. (canceled)

23. The method of claim 20, wherein the source cell is configured to provide a cell configuration, of the set of cell configurations, and a corresponding conditional handover condition, of the set of conditional handover conditions, via an information element.

24. The method of claim 20, wherein the configuration message is a radio resource control (RRC) message.

25. The method of claim 20, wherein the source cell is configured to group one or more candidate target cells, of the plurality of candidate target cells, into one or more configuration groups, and
wherein the configuration message identifies, for a configuration group of the one or more configuration groups, at least one of: a cell list, a group configuration, a cell-specific configuration, a cell physical cell identity, or a cell-specific dedicated configuration.

26. The method of claim 20, wherein the source cell is configured to receive the conditional handover execution message via at least one of:
a layer 1 (L1) signaling message,
a media access control (MAC) control element (CE) message, or
a layer 3 (L3) signaling message.

27. The method of claim 20, wherein the source cell is configured to receive a confirmation that the conditional handover procedure is complete from the UE or from the target cell.

28. The method of claim 20, wherein the source cell is configured to release reserved resources of the plurality of candidate target cells based at least in part on not receiving the conditional handover execution message before expiration of a conditional handover timer and to provide, to the UE, a reconfiguration information message to indicate the release of the reserved resources and cause a fallback to a non-conditional handover procedure.

29. The method of claim 20, wherein the source cell is configured to start a conditional handover timer to track a conditional handover evaluation period in connection with transmitting the configuration message with a conditional handover configuration,
wherein the source cell is configured to reset the conditional handover timer in connection with transmitting a subsequent configuration message with the conditional handover configuration after the configuration message, and
wherein the source cell is configured to send a reconfiguration information message to the UE to release the conditional handover configuration based at least in part on a conditional handover execution message not being received before expiration of a conditional handover time period.

30. (canceled)

31. (canceled)

32. The method of claim 20, wherein the source cell is configured to perform data forwarding to the target cell based at least in part on receiving the conditional handover execution message from the UE to enable the UE to transfer to the target cell or based at least in part on receiving a conditional handover complete message from the target cell to enable the UE to transfer to the target cell.

33. (canceled)

34. The method of claim 20, wherein the source cell is configured to trigger a fallback to a non-conditional handover upon reception of a measurement report from the UE during a conditional handover evaluation period.

35. The method of claim 20, wherein the source cell is configured to send a non-conditional handover command to the UE to trigger a fall back to a non-conditional handover.

36. The method of claim 20, wherein the source cell is configured to receive a conditional handover cancellation message from the UE during a conditional handover evaluation period and before the conditional handover procedure, and
wherein the source cell is configured to receive the conditional handover cancellation message via a measurement reporting event message or a radio resource control message.

37. (canceled)

38. A user equipment (UE) for wireless communication, comprising:
a memory; and
one or more processors operatively coupled to the memory, the memory and the one or more processors configured to:
determine to perform a conditional handover procedure to transfer from a source cell to a target cell of a plurality of candidate target cells;
transmit, to the source cell, a conditional handover execution message to indicate the conditional handover procedure to transfer from the source cell to the target cell based at least at least in part on determining to perform the conditional handover procedure; and
communicate with the target cell to transfer to the target cell based at least in part on determining to perform the conditional handover procedure.

39. The UE of claim 38, wherein the UE is configured to receive, from the source cell, a configuration message identifying a set of cell configurations and a set of conditional handover conditions for the plurality of candidate target cells.

40. (canceled)

41. (canceled)

42. (canceled)

43. (canceled)

44. A source cell for wireless communication, comprising:
a memory; and
one or more processors operatively coupled to the memory, the memory and the one or more processors configured to:
provide, to a user equipment (UE), a configuration message identifying a set of cell configurations for a plurality of candidate target cells and a set of conditional handover conditions for the plurality of candidate target cells;
receive, from the UE, a conditional handover execution message to indicate a conditional handover procedure to transfer from the source cell to a target cell of the plurality of candidate target cells after providing the configuration message; and
communicate with the target cell to enable the UE to transfer to the target cell based at least in part on receiving the conditional handover execution message.

45. (canceled)

46. (canceled)

47. (canceled)

48. (canceled)

49. (canceled)

50. (canceled)
